(19) United States
(12) Patent Application Publication
(10) Pub. No.: US 2025/0096645 A1
(43) Pub. Date: Mar. 20, 2025

(54) COOLANT SUPPLY SYSTEM FOR AN ELECTRIC VEHICLE AXLE DRIVE

(71) Applicant: AUDI AG, Ingolstadt (DE)

(72) Inventor: Ivo GREITER, Eitensheim (DE)

(73) Assignee: AUDI AG, Ingolstadt (DE)

(21) Appl. No.: 18/727,102

(22) PCT Filed: Oct. 28, 2022
(86) PCT No.: PCT/EP2022/080218

§ 371 Date: Jul. 8, 2024

(30) Foreign Application Priority Data
Jan. 14, 2022 (DE) 10 2022 100 804.5

(51) Int. Cl. H02K 9/12; H02K 9/197; H02K 9/26

(52) U.S. Cl. CPC H02K 9/12; H02K 9/197; H02K 9/26; H02K 2201/03; H02K 2205/12

(57) ABSTRACT

A coolant supply system for an electric vehicle axle drive with an electric machine, in the electric machine housing of which a stator interacts with a rotor which is spaced from the stator via an air gap, and the interior of the electric machine is supplied with coolant for internal rotor cooling and/or for stator cooling. The coolant supply system has a flow unit by which an air flow can be generated which flows through the air gap in the axial direction, whereby the air gap is kept substantially free of coolant to reduce rotor drag losses.

### FIELD

The invention relates to a coolant supply system for an electric vehicle axle drive.

### BACKGROUND

Such a vehicle axle drive can have a wet-running electric machine in which the stator, in particular the winding heads of the stator windings, and the rotor are actively cooled with coolant (that is, with oil). The rotor is separated from the stator by an air gap. The interior of the electric machine can be supplied with coolant for internal rotor cooling and/or stator cooling.

It has been shown that air containing coolant in the air gap between the rotor and the stator leads to drag losses in the rotor, which reduces the efficiency of the electric machine.

Against this background, compressed air lines are integrated in the rotor and/or stator, which are in fluid communication with the air gap, in a generic electric machine according to US 2021/0083555 A1. An air flow that flows through the air gap in the axial direction is generated for a compressed air source. In this way, the air gap is kept essentially free of coolant, which reduces rotor drag losses.

In US 2021/0083555 A1, the compressed air lines run inside the stator and/or rotor. The component geometry of the stator and/or rotor therefore differs significantly from a conventional rotor/stator component geometry in terms of manufacturing technology.

Other electric machines are known from EP 3 193 434 B1 and EP 3 032 709 A1. A generator for motor vehicles is known from US 2005/023909 A1. WO 2019/008220 A1 discloses an electric machine. A high-speed generator ventilation system for an air gap is known from U.S. Pat. No. 4,496,862 A. GB 164 114 discloses improvements on dynamoelectric machines. A cooling facility for electric machines is known from U.S. Pat. No. 3,240,967 A.

### SUMMARY

The object of the invention is to provide a coolant supply system for an electric vehicle axle drive, in which the electric machine can be operated in a simple manner with a higher degree of efficiency compared to the prior art.

According to the invention, a coolant supply system is provided for an electric machine, in the electric machine housing of which a stator interacts with a rotor which is spaced from the stator via an air gap. The electric machine is designed as a wet-running electric machine flown through by a coolant in which the interior of the electric machine is supplied with coolant for internal rotor cooling and/or for stator cooling. The coolant supply system also has a flow unit by means of which an air flow can be generated. The air flow passes through the air gap in axial direction. In this way, the air gap is kept essentially free of coolant, which helps reduce rotor drag losses. According to the characterizing part of claim 1, the rotor/stator arrangement has an air flow space on both axial sides (that is, the rotor space in this specific embodiment). The two air flow spaces are in fluid communication with the intermediate air gap. According to the invention, the air flow spaces (that is, the rotor spaces) are divided into an air inlet-side air flow space and an air outlet-side airflow space. The air flow generated by the flow unit flows via the air inlet into the air flow space on the air inlet side. The other flow path of the air flow leads through the air gap into the outlet-side airflow space. From there, the air flow is discharged from the outlet-side airflow space via an air outlet.

According to the invention, no geometric adjustments to the rotor and/or stator are required to achieve the air flow through the air gap. Instead, according to the invention, a conventional component geometry of the rotor or stator can be easily used in terms of manufacturing technology.

In a technical implementation, the two air flow spaces, the air gap, and the flow unit can be integrated into a closed air circuit. In the air circuit, the air flow generated by the flow unit flows via the air inlet into an inlet-side air flow space. From there, the air flow is guided axially through the air gap to the outlet-side airflow space. From the outlet-side airflow space, the air flow is further returned to the flow unit via the air outlet.

In the electric machine housing, the stator/rotor arrangement has a free housing space on both front sides. The air flow spaces according to the invention are components of these housing spaces. Preferably, each of the two front-side housing spaces is divided by a coolant separation into a radially outer winding head space and a radially inner rotor space, separated from the former in a largely fluid-tight manner and in which the rotor is arranged. In the radially outer winding head space, however, the stator is positioned together with the stator windings. In this way, the stator, which heats up considerably during electric machine operation, can be supplied with coolant in a more targeted manner. In addition, the coolant supply to the winding head space is largely decoupled from the rotor space. In particular, the winding heads of the stator can preferably be completely surrounded by coolant. In this case, the winding head space can be substantially completely filled with coolant.

In the above subdivision of the respective housing space into the radially outer winding head space and the radially inner rotor space, the radially inner rotor space in particular forms the air flow space according to the invention. In this case, the radially inner rotor spaces of the electric machine, in particular, are integrated into the air circuit. Against this background, the air inlet opens into the inlet-side rotor space, while the air outlet opens into the outlet-side rotor space.

With regard to reliable stator cooling, the winding head space can be part of a stator hydraulic circuit, which is preferably decoupled from the air circuit. The stator hydraulic circuit can have an inlet point at which coolant can be supplied from a coolant reservoir into the winding head space, in particular with the aid of a supply pump arranged in the coolant reservoir. In addition, the stator hydraulic circuit can have a drain point separate from the air outlet, from which coolant can be returned from the winding head space towards the coolant reservoir.

Alternatively and/or additionally, an internal rotor cooling system can be provided in which the rotor is part of a rotor hydraulic circuit. The rotor hydraulic circuit can also be largely decoupled from the air circuit and the stator hydraulic circuit.

The above-mentioned coolant separation between the winding head space and the radially inner rotor space forms a floor of the rotor space. During operation of the electric machine, leakage coolant escaping from the winding head space and/or leakage coolant escaping from the internal rotor cooling system or coolant escaping from the bearings can collect on the rotor space floor. It is preferred that the air outlet is arranged at the rotor space floor of the outlet-side rotor space. In this way, not only can the air flow be discharged via the air outlet, but also the leakage coolant can be discharged from the outlet-side rotor space. The mixture of air flow and leaked coolant can be returned to the coolant reservoir via a return line.

To avoid air containing coolant within the air gap, it is preferred that a separator is installed directly or indirectly upstream of the air inlet. With the help of the separator, the air flow entering the electric machine housing via the air inlet can be cleaned of coolant droplets.

In a first embodiment, the air outlet can be connected to a suction side of a return pump via a return line. The return pump acts as an air/coolant suction pump in which the mixture of air flow and leakage coolant can be sucked out of the rotor space. In this way, a negative pressure is created in the rotor space, which creates a pressure gradient between the transmission space and the rotor space, resulting in the air flow. The return pump can preferably be positioned within the coolant reservoir and have a riser on its pressure side. The mixture of air flow and leakage coolant can flow into the coolant reservoir via the riser. In addition, the air inlet can open into the air-filled upper interior of the coolant reservoir without a direct pump connection.

Alternatively, in a second embodiment, an air supply pump which acts as an air pressure pump can be arranged in the coolant reservoir. The air supply pump can have its suction side in fluid communication with the air-filled upper interior of the coolant reservoir. In this case, the air supply pump can suction off air from the air-filled upper interior of the coolant reservoir, which air is then pumped via an air supply line to the air inlet and from there further through the electric machine. In this case, the air outlet can be connected to the coolant reservoir via a return line. The return line can flow into the coolant reservoir without a direct pump connection. Preferably, the return line within the coolant reservoir can merge into a riser line through which the mixture of air flow and leakage coolant flows into the coolant reservoir.

It is preferred that a separator is installed upstream of the air supply pump on its suction side, with which the extracted air flow is cleaned of coolant droplets.

A design with reduced installation space and a simple construction is achieved if the flow unit is designed as a dual pump in which the feed pump for the stator cooling and/or for the internal rotor cooling and the return pump or feed pump for the air flow are combined to form a dual pump. In this case, the individual pumps installed in the dual pump can be driven by a common drive shaft.

The coolant separation is configured to be closed-surface (that is, nozzle-free) and in sealing contact with the end walls of the electric machine housing which are opposite one another in the axial direction. A fluid-tight or flow-tight seal between the winding head space and the rotor space does not necessarily mean a hermetic seal, that is, a completely tight seal. Instead, a slight coolant leakage through the sealing surfaces of the coolant separation into the rotor space may occur during electric machine operation.

The rotor hydraulic circuit can be specially designed for internal rotor cooling, in which the rotor shaft is configured as a hollow shaft. Coolant can flow at least through parts of the cavity. After the internal rotor cooling has been completed, the coolant can be discharged into the rotor space, where it accumulates at the bottom of the rotor space. As already mentioned, at least one rotor space drain point can be formed on the rotor space floor, via which the coolant can be returned to the coolant reservoir.

### BRIEF DESCRIPTION OF THE FIGURES

Two exemplary embodiments of the invention are described below with reference to the appended figures.

Wherein:

FIG. 1 shows a schematic representation of a first embodiment of a coolant supply system;

FIG. 2 shows a schematic representation of a second embodiment of a coolant supply system; and

FIG. 3 shows a schematic representation of a comparative example not covered by the invention.

### DETAILED DESCRIPTION

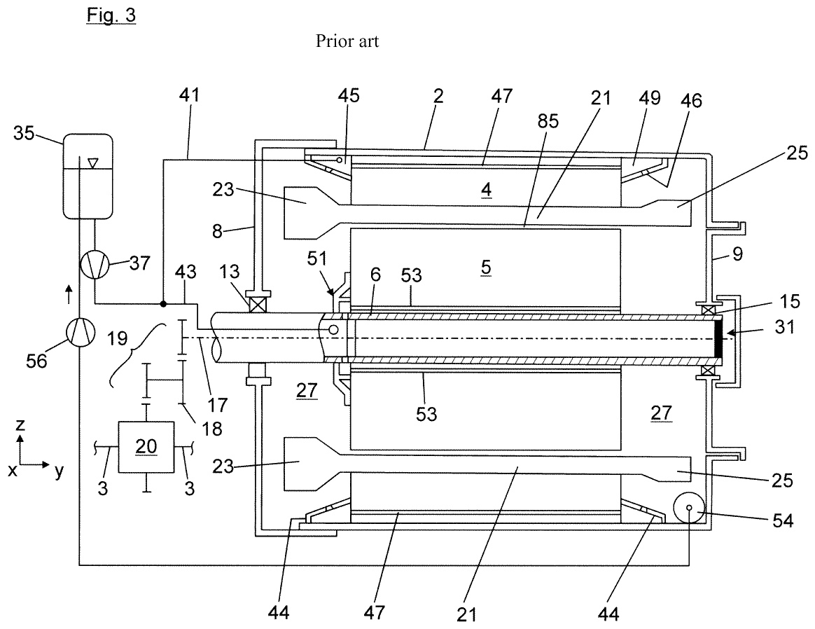

For an easier understanding of the invention, reference is first made to FIG. 3, in which a drive device for a vehicle axle of a two-track vehicle is indicated in a roughly schematic representation. The drive device has an electric machine which, for example, is installed transversely and arranged axially parallel to the flange shafts 3 guided to the vehicle wheels. A stator 4 and a rotor 5 interacting therewith are arranged in a stator housing 2 of the electric machine. The rotor shaft 6 is rotatably mounted in bearing openings on axially opposite housing walls 8, 9 of the stator housing 2, pivot bearings 13, 15 being arranged in between.

The rotor shaft 6 of the electric machine is connected in a rotationally fixed manner to a transmission input shaft 17 of a transmission arrangement 19, which outputs onto the two flange shafts 3. In FIG. 3, the transmission arrangement 19 is constructed from a transmission stage 18 and an axle differential 20.

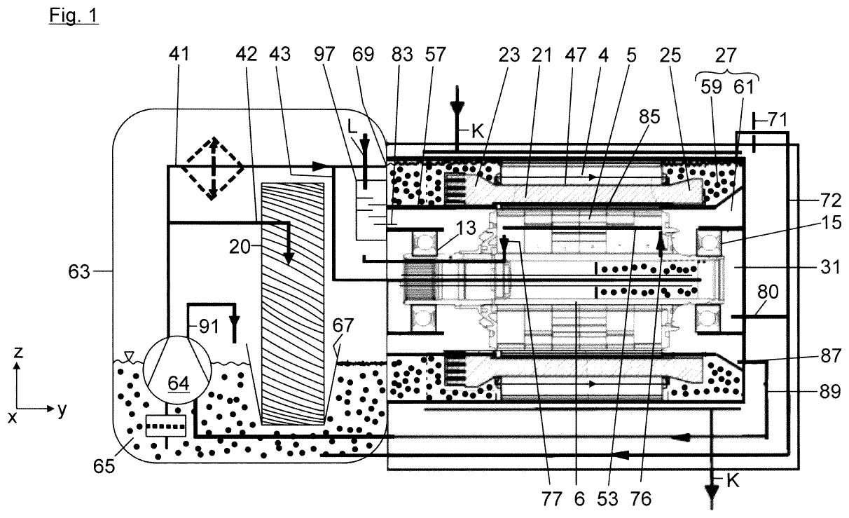

In FIG. 3, the stator 4 has a plurality of stator windings, of which only two stator windings 21 are roughly sketched in FIG. 1. Each stator winding 21 has a winding head 23, 25 on both axial sides, which project into a housing space 27. Each housing space 27 is integrated into an electric machine hydraulic circuit described later, with the help of which the respective housing space 27 can be supplied with coolant to cool the winding heads 23, 25 of the stator 4. In each of the housing spaces 27, an oil/air mixture moves in an eddy current flow around the rotor shaft 5, which rotates at high speed.

In the bearing arrangement on the right in FIG. 3, one shaft end of the rotor shaft 6 is rotatably mounted in a hub section 31 via the pivot bearing 15.

The oil hydraulic circuit has an oil tank 35 which is connected to a feed pump 37 via a suction line. A pressure line leads from the suction pump 37 to oil supply lines 41, 43. By means of the supply line 41, oil is fed into a radially outer circumferential annular gap 45. From there, the oil is guided via radially outer stator channels 47 to another annular gap 49 in the right housing space 27. The two annular gaps 45, 49 are separated from the respective housing space 27 via oil splash rings 44. Each of the oil splash rings 44 has nozzles 46 distributed in the circumferential direction, via which oil can be injected into the respective housing space 27.

By means of the supply line 43, oil is guided through the rotor shaft 6 and passed via a fluid communication 51 into radially inner stator channels 53 into the right housing space 27. In FIG. 3, there is a suction device 54 on the housing bottom of the electric machine housing, via which oil accumulating on the housing bottom can be returned to the oil tank 35 with the aid of a return pump 56.

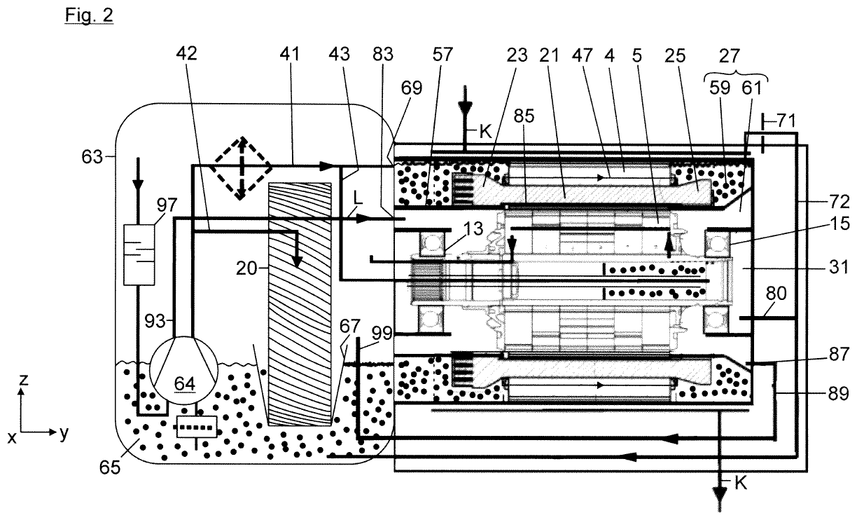

In contrast to FIG. 3, FIG. 1 or 2 show that the stator 4 with its winding heads 23, 25 is no longer cooled by means of an air/oil eddy current flow, according to the invention. Instead, the housing space 27 of the electric machine housing 2 is divided by means of a coolant separation 57 into a radially outer annular winding head space 59 and a radially inner rotor space 61. The stator 4 with its stator windings 21 is positioned in the winding head space 59, while the rotor 5 is arranged in the radially inner rotor space 61, separated from said winding head space in a fluid-tight manner. According to the invention, the stator 4 therefore no longer comes into cooling contact with an eddy current flow forming in the rotor space 61. Instead, in FIG. 1, the winding head space 59 is completely filled with the coolant during electric machine operation, so that coolant completely flows specifically around the winding heads 23, 25, which may result in a better efficiency compared to eddy current cooling.

A core of the invention consists, firstly, in accommodating the coolant in the unit at a location (that is, in the winding head space 59) where it is needed anyway. Secondly, the invention keeps the coolant largely away from the rotor space 61. When using the spray oil cooling known from the prior art from FIG. 3, there is a problem in that, depending on the temperature of the coolant, very different amounts of coolant remain on the winding. To provide a sufficient amount of coolant for the pressure pump, a comparatively large amount of coolant must be added.

As can be seen from FIG. 1, the electric machine is installed transversely in the vehicle, analogous to FIG. 3, with a rotor shaft 6 running in the vehicle transverse direction y, that is, axially parallel to the vehicle axis. In addition, in FIG. 1, the electric machine and the transmission arrangement 19 are arranged next to one another in the vehicle transverse direction y. The transmission housing 63 of the transmission arrangement 19 is also flanged directly to the electric machine housing 2. The transmission arrangement 19 is positioned in the transmission housing 63 and, according to FIG. 3, has the transmission stage 18 and the axle differential 20.

Another core of the invention is that a separate oil tank (reference numeral 35 in FIG. 3) is eliminated and instead the transmission housing 63 has a dual function as an oil tank or as a coolant reservoir in which an oil column 65 is formed. In addition, the feed pump 37 and return pump 56 shown in FIG. 3 are combined to form a common dual pump 64. In the dual pump 64, the feed and return pumps 37, 56 are driven by an electric motor with a common drive shaft (not shown).

As can be seen from FIG. 1, a shell 67 which is open at the top is positioned as a hollow body at the bottom of the transmission housing 63 and shields a coolant-free, open-topped installation space 69 from the oil column 65. The axle differential 20 partially protrudes into the installation space 69. Normally, injection lubrication is used, in which oil is fed via the transmission supply line 42 towards the axle differential 20. The coolant dripping from the axle differential 20 accumulates at the bottom of the bowl 67 and is then led, if necessary, via a drain point (not shown) into the return line 89, which is connected to the suction side of the dual pump 64. Alternatively, it may be sufficient for the differential transmission to throw the coolant out of the shell 67. In addition, it would be possible to form a small oil inlet hole in the shell 67 to ensure emergency lubrication of the transmission in the event of a pump failure.

During electric machine operation, oil is fed into the winding head space 59 via the supply line 41 at an inlet point 69 close to the transmission unit by means of the dual pump 64. The oil is drained from the winding head space 59 at an axially opposite drain point 71, remote from the transmission unit. The winding head space drain point 71 remote from the transmission unit can be implemented as an orifice, possibly also as a pressure relief valve. The orifice or pressure relief valve is required to keep the oil in the winding head spaces 59 even at very high accelerations, in particular lateral accelerations. The winding head space drain point 71 is also in fluid communication via a first return line 72 with the oil column 65 located in the transmission housing 63, into which the first return line 72 opens. In addition, an oil supply line 80 branches off from the return line 72. The bearing 15 in the hub section 31 is supplied with oil via the oil supply line 80. The oil then passes through the bearing 15 into the rotor space 61, from where it is suctioned out via a return line 89.

In FIG. 1, the coolant supply system is used to cool the rotor internally, resulting in an oil guide as outlined in FIG. 1. The oil guide in the rotor shaft 6 is designed such that both the bearing 13 close to the transmission unit and the bearing 15 remote from the transmission unit are cooled from the inside. The aim of the oil guide is to achieve the smallest possible temperature difference between the inner ring and the outer ring of the respective bearing 13, 15.

According to the oil guide, the oil is fed via the supply line 43 into the cavity of the rotor shaft 6, which is configured as a hollow shaft, up to the axial height of the rotary bearing 15 remote from the transmission unit. From there, the oil is guided into the rotor channels 53 via a fluid communication 76 remote from the transmission unit. In the rotor channels 53, the oil then flows in the opposite direction to a fluid communication 77 close to the transmission unit, where the oil is returned to the cavity of the rotor shaft 6.

Another core of the invention is that the coolant supply system has an additional closed air circuit. The following components are integrated in the closed air circuit, namely the dual pump 64, an air inlet 83, the inlet-side rotor space 61, an air gap 85 between the rotor 5 and the stator 4, and an air outlet 87 on the outlet side rotor space 61. The air outlet 87 on the outlet-side rotor space 61 is positioned on the bottom side of the coolant separation 57. During operation of the electric machine, a leakage coolant accumulates on the bottom side of the coolant separator 57, which escapes from the winding head space 59 and from the bearings 13 and 15, both of which are oil-lubricated. In addition, leakage coolant from the internal rotor cooling system accumulates. Not only the leakage coolant is discharged via the air outlet 87, but also an air flow L described later, which is circulated in the closed air circuit.

In FIG. 1, the air outlet 87 is connected via a return line 89 to a suction side of the return pump integrated in the dual pump 64. By means of the return pump integrated in the dual pump 64, the mixture of the air flow L and the leakage coolant is suctioned out of the outlet-side rotor space 61, specifically with the formation of negative pressure in the outlet-side rotor space 61, whereby a pressure gradient is created between the transmission space 63 and the rotor space 61, resulting in the air flow. The return pump integrated in the dual pump 64 has a riser 91 on its pressure side, via which the mixture of air flow L and leakage coolant flows into the transmission housing 63. This occurs by creating excess pressure in the transmission housing 63.

As can be seen from FIG. 1, the air inlet 83 opens freely, that is, without a direct pump connection, into the air-filled upper interior of the transmission housing 63. In this way, a pressure gradient arises between the air-filled upper interior of the transmission housing 63 and the inlet-side rotor space 61, whereby the air flow L is formed.

FIG. 2 shows an alternative embodiment in which an air supply pump (not shown) is integrated in the dual pump 64. This suctions air from the air-filled upper interior of the transmission housing 63, which is connected to the air inlet 83 via an air supply line 93. In addition, in FIG. 2, the air outlet 87 is connected to the transmission housing 63 via a return line 89. In FIG. 2, the return line 89 opens into the transmission housing 63 without a direct pump connection. Instead, the return line 89 ends with a riser line 99, via which the mixture of air flow L and coolant is fed into the transmission housing 63.

As can be seen from FIGS. 1 and 2, an oil separator 97 is arranged directly or indirectly upstream of the air inlet 87. By means of the oil separator 97, the air flow L is cleaned of coolant droplets before the air flow L enters the inlet-side rotor space 61.

In FIGS. 1 and 2, the electric machine is additionally integrated in a cooling water circuit K, in which the cooling water flows around the outer circumference of the electric machine housing 2.

### LIST OF REFERENCE NUMERALS

2 electric machine housing
3 flange shafts
4 stator
5 rotor
6 rotor shaft
8, 9 housing wall
11 bearing opening
13, 15 pivot bearing
17 transmission input shaft
18 transmission stage
19 transmission arrangement
20 axle differential
21 stator winding
23, 25 winding head
27 electric machine space
31 hub section
33 sealing element
35 coolant tank
37 feed pump
41, 42, 43 supply lines
44 oil splash ring
45 annular gap
46 nozzles
47 radially outer stator channel
49 annular gap
51 fluid communication
53 radially inner stator channel
54 suctioning off
56 return pump
57 coolant separation
59 winding head space
61 rotor space
63 transmission housing
64 dual pump
65 coolant column
66 riser
67 hollow bodies
68 hollow body discharge point
69 winding head space inlet point
71 winding head space discharge point
72 other return line
76 fluid communication remote from the transmission unit
77 fluid communication close to the transmission unit
80 coolant supply line
83 air inlet
85 air gap
87 air outlet
89 return line
91 riser
93 air supply line
97 oil separator
99 riser
L air flow
K cooling water circuit

1-10. (canceled)

11. A coolant supply system for an electric vehicle axle drive with an electric machine, in the electric machine housing of which a stator interacts with a rotor which is spaced from the stator via an air gap, wherein the interior of the electric machine is supplied with coolant for internal rotor cooling and/or for stator cooling, and wherein the coolant supply system has a flow unit by which an air flow can be generated which flows through the air gap in the axial direction, whereby the air gap is kept substantially free of coolant to reduce rotor drag losses, wherein an air flow space is located axially on both sides of the rotor/stator arrangement, in that the two air flow spaces are in fluid communication with the air gap, and in that in particular the two air flow spaces are divided into an inlet-side air flow space, into which the air flow flows via an air inlet, and an outlet-side airflow space with an air outlet from which the air flow flows out.

12. The coolant supply system according to claim 11, wherein the two air flow spaces, the air gap, and the flow unit are integrated in an air circuit in which the air flow generated by the flow unit flows into the inlet-side air flow space via the air inlet, can be guided axially through the air gap, and can be returned from the outlet-side airflow space to the flow unit via the air outlet.

13. The coolant supply system according to claim 11, wherein the rotor/stator arrangement has a front-side housing space on each axial side, and in that the air flow space is part of the front-side housing space, and in that a coolant separation is arranged in the electric machine housing, which divides each housing space into a radially outer winding head space and a radially inner rotor space separated from the former in a largely fluid-tight manner, in which the rotor is arranged and which forms the air flow space.

14. The coolant supply system according to claim 13, wherein the air inlet opens into the inlet-side rotor space, while the air outlet opens into the outlet-side rotor space.

15. The coolant supply system according to claim 13, wherein the winding head space is part of a stator hydraulic circuit which has an inlet point at which coolant can be fed from a coolant reservoir into the winding head space, in particular by a feed pump, and in that the stator hydraulic circuit has an outlet point from which coolant can be returned from the winding head space in the direction of the coolant reservoir.

16. The coolant supply system according to claim 13, wherein the coolant separation forms a floor of the rotor space, on which a leakage coolant escaping from the winding head chamber and/or a leakage coolant escaping from the internal rotor cooling and/or a coolant escaping from the bearings accumulates, and in that the air outlet is arranged on the rotor space floor of the outlet-side rotor space, via which both leakage coolant and the air flow can be discharged.

17. The coolant supply system according to claim 11, wherein a separator is connected directly or indirectly upstream of the air inlet, by which the air flow can be cleaned of coolant droplets.

18. The coolant supply system according to claim 16, wherein the air outlet is connected via a return line to a suction side of a return pump, which suctions the mixture of air flow and leakage coolant from the outlet-side rotor space, specifically with the formation of negative pressure in the rotor space, whereby a pressure gradient arises between the coolant reservoir and the rotor space, resulting in the air flow, and in that in particular the return pump has a riser on its pressure side, via which the mixture of air flow and leakage coolant flows into the coolant reservoir, and/or in that in particular the air inlet opens into the air-filled upper interior of the coolant reservoir without a direct pump connection, such that the air flow through the air inlet is due to a pressure gradient between the coolant reservoir and the rotor space.

19. The coolant supply system according to claim 16, wherein an air supply pump is arranged in the coolant reservoir, which suctions air from the air-filled upper interior of the coolant reservoir and is connected to the air inlet via an air supply line, and in that the air outlet is connected to the coolant reservoir via a return line which opens into the coolant reservoir without a direct pump connection.

20. The coolant supply system according to claim 15, wherein the feed pump for the stator cooling and/or the internal rotor cooling and the return pump or feed pump for the air flow are combined to form a dual pump forming the flow unit, in which the pumps can be driven with a common drive shaft.

21. The coolant supply system according to claim 12, wherein the rotor/stator arrangement has a front-side housing space on each axial side, and in that the air flow space is part of the front-side housing space, and in that a coolant separation is arranged in the electric machine housing, which divides each housing space into a radially outer winding head space and a radially inner rotor space separated from the former in a largely fluid-tight manner, in which the rotor is arranged and which forms the air flow space.

22. The coolant supply system according to claim 14, wherein the winding head space is part of a stator hydraulic circuit which has an inlet point at which coolant can be fed from a coolant reservoir into the winding head space, in particular by a feed pump, and in that the stator hydraulic circuit has an outlet point from which coolant can be returned from the winding head space in the direction of the coolant reservoir.

23. The coolant supply system according to claim 14, wherein the coolant separation forms a floor of the rotor space, on which a leakage coolant escaping from the winding head chamber and/or a leakage coolant escaping from the internal rotor cooling and/or a coolant escaping from the bearings accumulates, and in that the air outlet is arranged on the rotor space floor of the outlet-side rotor space, via which both leakage coolant and the air flow can be discharged.

24. The coolant supply system according to claim 15, wherein the coolant separation forms a floor of the rotor space, on which a leakage coolant escaping from the winding head chamber and/or a leakage coolant escaping from the internal rotor cooling and/or a coolant escaping from the bearings accumulates, and in that the air outlet is arranged on the rotor space floor of the outlet-side rotor space, via which both leakage coolant and the air flow can be discharged.

25. The coolant supply system according to claim 12, wherein a separator is connected directly or indirectly upstream of the air inlet, by which the air flow can be cleaned of coolant droplets.

26. The coolant supply system according to claim 13, wherein a separator is connected directly or indirectly upstream of the air inlet, by which the air flow can be cleaned of coolant droplets.

27. The coolant supply system according to claim 14, wherein a separator is connected directly or indirectly upstream of the air inlet, by which the air flow can be cleaned of coolant droplets.

28. The coolant supply system according to claim 15, wherein a separator is connected directly or indirectly upstream of the air inlet, by which the air flow can be cleaned of coolant droplets.

29. The coolant supply system according to claim 16, wherein a separator is connected directly or indirectly upstream of the air inlet, by which the air flow can be cleaned of coolant droplets.

30. The coolant supply system according to claim 17, wherein the air outlet is connected via a return line to a suction side of a return pump, which suctions the mixture of air flow and leakage coolant from the outlet-side rotor space, specifically with the formation of negative pressure in the rotor space, whereby a pressure gradient arises between the coolant reservoir and the rotor space, resulting in the air flow, and in that in particular the return pump has a riser on its pressure side, via which the mixture of air flow and leakage coolant flows into the coolant reservoir, and/or in that in particular the air inlet opens into the air-filled upper interior of the coolant reservoir without a direct pump connection, such that the air flow through the air inlet is due to a pressure gradient between the coolant reservoir and the rotor space.
